(19) United States
(12) Patent Application Publication
(10) Pub. No.: US 2012/0045234 A1
(43) Pub. Date: Feb. 23, 2012

(54) IMAGE FORMING APPARATUS

(75) Inventors: Shinya Suzuki, Toride-shi (JP); Katsumi Takahashi, Moriya-shi (JP)

(73) Assignee: CANON KABUSHIKI KAISHA, Tokyo (JP)

(21) Appl. No.: 13/210,231

(22) Filed: Aug. 15, 2011

(30) Foreign Application Priority Data
Aug. 18, 2010 (JP) 2010-183269

(51) Int. Cl. G03G 15/00; G03G 15/01

(52) U.S. Cl. 399/49; 399/301

(57) ABSTRACT

No registration pattern can be formed with a reference density due to environmental changes. In such a case, any registration cannot be formed until an image forming apparatus is controlled to be able to form a registration pattern with the reference density. To solve this problem, a CPU included in the image forming apparatus controls pattern forming conditions so that registration patterns of respective colors can match one another in density lower than the reference density. The CPU controls each image forming unit to form a registration pattern based on the controlled pattern forming conditions.

### BACKGROUND OF THE INVENTION

1. Field of the Invention

The present invention relates to an image forming apparatus of an electrophotographic process type, and more particularly to an image forming apparatus that has a color misregistration correction function.

2. Description of the Related Art

There has conventionally been known a color image forming apparatus that forms toner images of different colors on a plurality of photosensitive members, and transferring the toner images to a recording medium to form a color image.

One of such color image forming apparatuses each including the plurality of photosensitive members is an image forming apparatus that includes an intermediate transfer member to which the toner images formed on the plurality of photosensitive members are transferred, and transfers the toner images transferred to the intermediate transfer member to the recording medium. There is also an image forming apparatus that directly transfers the toner images formed on the plurality of photosensitive members to the recording medium conveyed on a conveyance belt.

Such a color image forming apparatus is designed to prevent misregistration of the toner images formed on the plurality of photosensitive members on the recording medium.

However, component tolerance or positional changes of components due to a temperature increase of the apparatus during image formation cause color misregistration in which the toner images to be superimposed on each other on the recording medium are not superimposed. Hence, the color image forming apparatus suppresses the occurrence of color misregistration by executing color misregistration correction control.

According to one of color misregistration correction methods, a position detection pattern formed on each photosensitive member corresponding to each color is formed on the intermediate transfer member, the conveyance belt, or the recording medium, and a forming position of the position detection pattern of each color is detected. A relative position of the position detection pattern of each color is detected from the detection result, and a relative deviation amount between the position detection patterns is calculated based on a relative position relationship. A forming position of a toner image formed on each photosensitive member is then corrected to reduce the calculated relative deviation amount.

In the color misregistration correction control, an optical sensor is used for detecting the position detection pattern. The optical sensor includes a light emitting unit and a light receiving unit. In the case of the apparatus that forms the position detection patterns on the intermediate transfer member, the intermediate transfer member and the position detection pattern are irradiated with light from the light emitting unit, and the light reflected from the intermediate transfer member and the position detection pattern is received by the light receiving unit.

The light receiving unit outputs an analog signal of a level corresponding to a reflected light amount from each of the intermediate transfer member and the position detection pattern. The analog signal is converted into a digital signal based on a predetermined threshold value. A relative position of the position detection pattern of each color on the intermediate transfer member is then detected based on a center-of-gravity position of a pulse of the digital signal, or timing of a rising edge or a falling edge of the pulse.

Even when images are formed on the same image forming conditions, because of fluctuation in characteristics of the image forming apparatus caused by a change of an environment where the image forming apparatus is located, densities of output images may not become as desired.

For example, a density of an image decreases when a toner charge amount increases. In the case of the image forming apparatus that uses a developer containing toner and a carrier, the developer is agitated to rub the toner and the carrier in a developing device. Rubbing the toner and the carrier charges the toner.

The toner charge amount is influenced by humidity. Toner charges move into toner ambient water vapor. A charge amount discharged from the toner increases when a water vapor amount is large. A toner charge amount at humidity of 70% is accordingly smaller than that at humidity of 30%. Thus, when images are formed based on the same image data, a density of the image formed at the humidity of 70% becomes higher than that of the image formed at the humidity of 30%.

In order to correct such fluctuation in density of the output images, in the imager forming apparatus of the electrophotographic type, a density detection pattern (hereinafter, referred to as a density patch to distinguish from density detection pattern below) is formed each time a predetermined condition is satisfied, and image forming conditions are controlled so that the density patch can approximately match a reference density. Periodically executing such density correction control prevents mismatching between a density of a document image and a density of an output image caused by fluctuation in characteristics of the image forming apparatus.

As in the case of the density of the output image, a density of the position detection pattern changes due to environmental changes or fluctuation in characteristics of the image forming apparatus. A density change amount of the position detection pattern varies from color to color. Consequently, output levels of pulses output from the optical sensors corresponding to the position detection patterns of respective colors do not become equal.

More specifically, when densities of the position detection patterns are nonuniform, a rising speed or a falling speed of a pulse of an analog signal corresponding to the position detection pattern of each color changes. The changed rising speed or falling speed of the pulse of the analog signal causes a change in timing of a rising edge or a falling edge of a pulse of a digital signal generated from the analog signal.

To be precise, a change amount of the rising edge or the falling edge of the pulse of the analog signal varies from color to color. This causes inclusion of a difference in edge change amount in a color misregistration amount detected from the pulse of the digital signal. As a result, detection accuracy of the relative position relationship of the position detection pattern is reduced.

In order to solve the problem, Japanese Patent Application Laid-Open No. 2010-48904 discusses an image forming apparatus that forms, before formation of a position detection pattern, a density detection pattern to adjust forming conditions of the position detection pattern, and controls the forming conditions of the position detection pattern based on a detection result of the density detection pattern.

A density of the density detection pattern is formed on the same condition as that of the position detection pattern. When the detected density of the density detection pattern is different from a reference density, the forming conditions of the position detection pattern are controlled so that the position detection pattern can be formed with a reference density.

However, when fluctuation in characteristics of the image forming apparatus reduces the density of the position detection pattern, the following problem occurs. When a toner charge amount of at least one color among colors greatly increases, a toner image of the color cannot be formed with the reference density. In this case, levels of pulses of analog signals corresponding to the position detection patterns of the respective colors cannot be set equal. As a result, detection accuracy of the position detection patterns deteriorates.

Replenishing the apparatus with new toner enables reduction of the toner charge amount. However, the toner charge amount does not immediately decrease even when the new toner is supplied, and hence the density of the position detection pattern does not immediately increase. In other words, the position detection pattern formation must be waited until the toner charge amount drops to a level at which the position detection pattern can be formed with the reference density, consequently generating down time.

The density of the position detection pattern may be increased by enlarging a pulse width of a pulse-width modulation (PWM) signal supplied to a light source to form the position detection pattern. The position detection pattern must be formed with a high density to assure detection of the optical sensor, and thus the pulse width of the PWM signal to form the position detection pattern is originally set large (maximum pulse width). As a result, the density of the position detection pattern may not be increased to the reference density by enlarging the pulse width of the PWM signal to a limit.

Increasing exposure intensity for exposing the photosensitive member to form the position detection pattern enables an increase of the density of the position detection pattern. However, when the density of the position detection pattern greatly drops below the reference density, the exposure intensity must be greatly increased. In this case, when the exposure intensity is increased more than necessary, deterioration of a photosensitive layer in a position where the position detection pattern is formed is expedited.

### SUMMARY OF THE INVENTION

According to an aspect of the present invention, an image forming apparatus includes an image forming unit configured to form toner images on an image bearing member by using first toner and second toner different from the first toner, the image forming unit being configured to form, on the image bearing member, a first position detection pattern by using the first toner and a second position detection pattern by using the second toner; a detection unit configured to detect the first position detection pattern and the second position detection pattern, the detection unit being configured to output a first signal according to a density of the first position detection pattern and a second signal according to a density of the second position detection pattern; a correction unit configured to correct relative positions of the toner image formed by the first toner and the toner image formed by the second toner on the image bearing member based on the first signal and the second signal; and a control unit configured to control, in a case in which an output level of the first signal reaches a predetermined level corresponding to the first signal while an output level of the second signal does not reach a predetermined level corresponding to the second signal, the density of the second position detection pattern so that the second signal having the level not reaching the predetermined level corresponding to the second signal can be output from the detection unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a schematic sectional view illustrating an image forming apparatus according to a first exemplary embodiment.

FIG. 2 is schematic sectional view illustrating a photosensor included in the image forming apparatus according to the first exemplary embodiment.

FIG. 3 schematically illustrates a scanner unit included in the image forming apparatus according to the first exemplary embodiment.

FIG. 4 is a control block diagram illustrating the image forming apparatus according to the first exemplary embodiment.

FIG. 5 illustrates an intermediate transfer belt, the photosensor, a driving roller, and a driven roller included in the image forming apparatus according to the first exemplary embodiment.

FIG. 6 illustrates a registration pattern and a density pattern formed on the intermediate transfer belt.

FIGS. 7A to 7C illustrate a superimposed pattern, an analog signal acquired by detecting the superimposed pattern, and a digital signal acquired by converting the analog signal.

FIG. 8 illustrates a waveform of the analog signal.

FIG. 9 is a flowchart illustrating control processing executed by a central processing unit (CPU) according to the first exemplary embodiment.

FIGS. 10A to 10D are conceptual diagrams illustrating an image forming position correction method in a sub-scanning direction.

FIG. 11 (11A+11B) is a flowchart illustrating control processing executed by a CPU according to a second exemplary embodiment.

FIG. 12 illustrates a different photosensor 1201 used in the first exemplary embodiment.

FIGS. 13A and 13B illustrate outputs from a charge coupled device (CCD) 1202 of the photosensor 1201.

FIG. 14 schematically illustrates a registration pattern 1401 when the photosensor 1201 is used.

### DESCRIPTION OF THE EMBODIMENTS

Various exemplary embodiments, features, and aspects of the invention will be described in detail below with reference to the drawings.

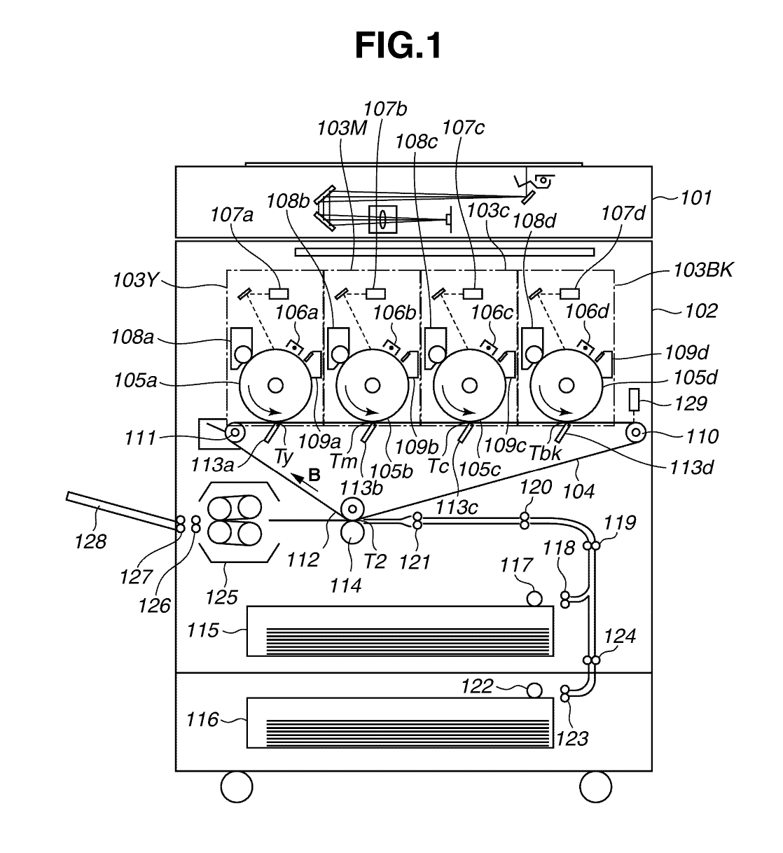

FIG. 1 is a sectional view schematically illustrating an image forming apparatus according to a first exemplary embodiment of the present invention.

The image forming apparatus according to the present exemplary embodiment includes an image reading unit 101 and an image output unit 102. The image reading unit 101 irradiates a document image with light, reads reflected light from the document image by a sensor, and converts a reading result into an electric signal to transmit it to the image output unit 102.

The image output unit 102 forms an image based on image data transmitted from the image reading unit 101. The image output unit 102 is configured to receive image data from an external information apparatus, such as a personal computer (PC) or the like, and can form an image based on the image data received from the external information apparatus.

The image output unit 102 forms an image on a recording medium by using toner of a plurality of colors (yellow, magenta, cyan, and black). The present exemplary embodiment is described, for convenience, with a toner image formed by each of yellow, magenta, and cyan among the plurality of colors defined as a color toner image, and a toner image formed by black toner defined as a black toner image.

The image output unit 102 includes an image forming unit 103Y that forms a yellow toner image, an image forming unit 103M that forms a magenta toner image, an image forming unit 103C that forms a cyan toner image, and an image forming unit 103Bk that forms a black (Bk) toner image. As illustrated in FIG. 1, the four image forming units are arranged side by side with respect to an intermediate transfer belt (intermediate transfer member) 104 that is an image bearing member.

The image forming unit 103Y includes a photosensitive drum 105a that is a photosensitive member, a charging device 106a that charges the photosensitive drum 105a, and an exposure device 107a that exposes the photosensitive drum 105a charged by the charging device 106a.

The image forming unit 103Y includes a developing device 108a that develops an electrostatic latent image formed on the photosensitive drum 105a by yellow toner. The developing device 108a holds a developer containing toner and a carrier.

The developer in the developing device 108a is agitated by an agitation member. Because of the agitation, the toner and the carrier are rubbed to charge the toner. The charged toner adheres to the electrostatic latent image. Toner left without being transferred to the intermediate transfer belt 104 is recovered by a cleaning device 109a.

The image forming unit 103M includes a photosensitive drum 105b that is a photosensitive member, a charging device 106b that charges the photosensitive drum 105b, and an exposure device 107b that exposes the photosensitive drum 105b charged by the charging device 106b.

The image forming unit 103M further includes a developing device 108b that develops an electrostatic latent image formed on the photosensitive drum 105b by magenta toner, and a cleaning device 109b that recovers toner left without being transferred to the intermediate transfer belt 104.

The image forming unit 103C includes a photosensitive drum 105c that is a photosensitive member, a charging device 106c that charges the photosensitive drum 105c, and an exposure device 107c that exposes the photosensitive drum 105c charged by the charging device 106c. The image forming unit 103C further includes a developing device 108c that develops an electrostatic latent image formed on the photosensitive drum 105c by cyan toner, and a cleaning device 109c that recovers toner left without being transferred to the intermediate transfer belt 104.

The image forming unit 103Bk includes a photosensitive drum 105d that is a photosensitive member, a charging device 106d that charges the photosensitive drum 105d, and an exposure device 107d that exposes the photosensitive drum 105d charged by the charging device 106d.

The image forming unit 103Bk further includes a developing device 108d that develops an electrostatic latent image formed on the photosensitive drum 105d by black toner, and a cleaning device 109d that recovers toner left without being transferred to the intermediate transfer belt 104.

Next, an image forming process in each of the image forming units 103Y, 103M, 103C, and 103Bk is described. The image forming units 103Y, 103M, 103C, and 103Bk of the image forming apparatus according to the present exemplary embodiment are similar in configuration. Thus, the image forming process in the image forming unit 103Y is representatively described.

The photosensitive drum 105a is supported on its center to freely rotate, and driven to rotate in an illustrated arrow direction. The charging device 106a, the developing device 108a, and a cleaning device 109a are arranged facing to an outer circumference surface of the photosensitive drum 105a and along its rotational direction. The charging device 106a uniformly applies charges on a surface of the photosensitive drum 105a.

The photosensitive drum 105a with its surface being charged is exposed to a laser beam (optical beam) emitted from the exposure device 107a. A light source (described below) included in the exposure device 107a to emit a laser beam is controlled to be lit or unlit based on image data input from the image reading unit 101 or the external information apparatus such as a PC.

The laser beam emitted from the exposure device 107a is guided to the surface of the photosensitive drum 105a between the charging device 106a and the developing device 108a to expose the photosensitive drum 105a thereto. An electrostatic latent image based on the image data is formed on the photosensitive drum 105a exposed to the laser beam.

The electrostatic latent image formed on the photosensitive drum 105a is then developed by the developing device 108a. Toner held by the developing device 108a is yellow, and hence a yellow toner image is formed on the photosensitive drum 105a.

Through image forming processes similar to the image forming process described above, a magenta toner image, a cyan toner image, and a black toner image are respectively formed on the photosensitive drum 105b, the photosensitive drum 105c, and the photosensitive drum 105d.

Next, a process of transferring and fixing the toner images of the respective colors formed on the photosensitive drums 105a, 105b, 105c, and 105d of the image forming units 103Y, 103M, 103C, and 103Bk of the respective colors is described.

The toner images of yellow, magenta, cyan, and black formed on the photosensitive drums 105a, 105b, 105c, and 105d are transferred to the intermediate transfer belt 104. The intermediate transfer belt 104 is stretched around the driving roller 101 and the driven rollers 111 and 112, and driven to rotate in an arrow direction B. The toner image on the photosensitive drum 105a is transferred to the intermediate transfer belt 104 at a primary transfer portion Ty by a primary transfer device 113a.

Similarly, the toner image on the photosensitive drum 105b is transferred to the intermediate transfer belt 104 at a primary transfer portion Tm by a primary transfer device 113b, the toner image on the photosensitive drum 105c is transferred to the intermediate transfer belt 104 at a primary transfer portion Tc by a primary transfer device 113c, and the toner image on the photosensitive drum 105d is transferred to the intermediate transfer belt 104 at a primary transfer portion Tbk by a primary transfer device 113d.

The toner images on the intermediate transfer belt 104 are transferred to a recording medium such as paper at a secondary transfer portion T2 by a secondary transfer device 114. The recording medium is housed in sheet feeding cassettes 115 and 116. The recording medium housed in the sheet feeding cassette 115 is conveyed from the sheet feeding cassette 115 by a feed roller 117, and conveyed to the secondary transfer portion T2 by feed rollers 118, 119, 120, and 121.

The recording medium housed in the sheet feeding cassette 116 is conveyed from the sheet feeding cassette 116 by a feed roller 122, and conveyed to the secondary transfer portion T2 by feed rollers 123, 124, 119, 120, and 121. The conveying speed of the recording medium is adjusted by controlling the rotational speed of the feed roller so that the toner image on the intermediate transfer belt 104 can be transferred to a desired position on the recording medium at the secondary transfer portion T2.

The recording medium to which the toner image has been transferred at the secondary transfer portion is conveyed to a fixing device 125. The fixing device 125 heats and fixes the toner image on the recording medium. The recording medium passed through the fixing device 125 is discharged to a discharge tray 128 (discharge unit) by discharge rollers 126 and 127.

As illustrated in FIG. 1, the image forming apparatus according to the present exemplary embodiment includes an optical sensor (photosensor) 129 used on the intermediate transfer belt 104 when color misregistration correction control is performed. As illustrated in FIG. 1, the photosensor 129 is located to face the driving roller 110.

As described below, the photosensor 129 is installed to detect a position detection pattern (hereinafter, registration pattern) formed on the intermediate transfer belt 104 during color misregistration correction control. The photosensor 129 also detects a density detection pattern (hereinafter, density pattern) formed on the intermediate transfer belt 104 to adjust registration pattern forming conditions.

In the present exemplary embodiment, the registration pattern and the density pattern are detected by the same photosensor. However, a first photosensor that is a first detection unit for detecting the registration pattern and a second photosensor that is a second detection unit for detecting the density pattern can individually be provided.

In this case, the second photosensor is located near the intermediate transfer belt 104 to be able to detect the density pattern on the intermediate transfer belt 104. Alternatively, the second photosensor is located near each photosensitive drum to be able to detect a density pattern of each color on each photosensitive drum.

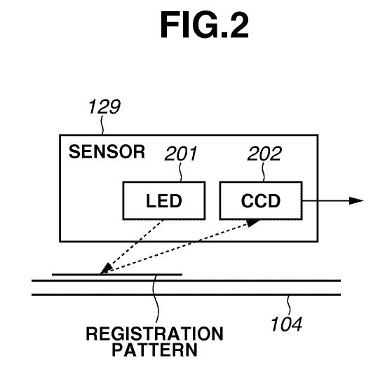

The photosensor 129 is provided to detect a relative forming position of a registration pattern of each color and a density of a density pattern on the intermediate transfer belt 104. FIG. 2 is a sectional view schematically illustrating the photosensor 129. As illustrated in FIG. 2, the photosensor 129 includes a light-emitting diode (LED) 201 that is a light emitting unit and a charge-coupled device (CCD) 202 that is a light receiving unit.

Photosensors 129 are arranged in at least two positions to detect the registration pattern and the density pattern formed in different positions in a longitudinal direction of the driving roller 110. The CCD 202 is set at a position to which diffused reflected light from the registration pattern and the density pattern of light emitted from the LED 201 enters.

The LED 201 emits light to the intermediate transfer belt 104. The CCD 202 receives diffused reflected light from the intermediate transfer belt 104, and the diffused reflected light from the registration pattern and the density pattern described below.

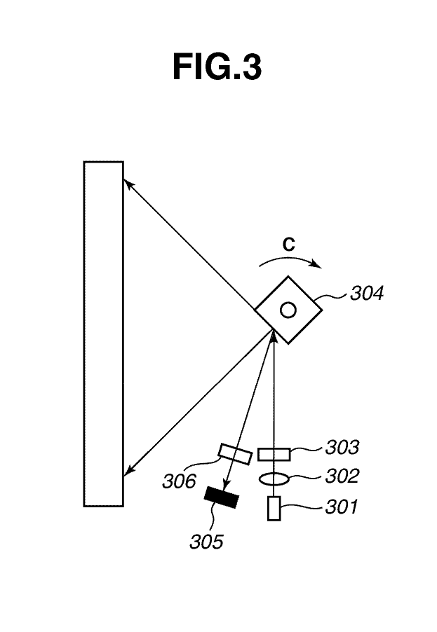

Next, a laser scanner unit that is an exposure device is described. FIG. 3 schematically illustrates the laser scanner unit and the photosensitive drum exposed to the laser scanner unit. Laser scanner units 107a to 107d included in the image forming apparatus according to the present exemplary embodiment are similar in configuration, and thus the configuration of the laser scanner unit 107a is representatively described.

The laser scanner unit 107a includes a semiconductor laser 301 that is a light source. As described above, the semiconductor laser 301 is controlled to be lit or unlit based on the image data input from the image reading unit 101 or the external information device.

A laser beam emitted from the semiconductor laser 301 enters a collimator lens 302. The collimator lens 302 coverts the laser beam as radiated light into parallel light. The laser beam passed through the collimator lens 302 enters a cylindrical lens 303. The cylindrical lens 303 causes the laser beam that has become the parallel light to form an image on a polygon mirror 304 (rotational polygon mirror) that is a deflection-scanning unit.

During image formation, the polygon mirror 304 is driven to rotate in an arrow direction C illustrated in FIG. 3 by a drive motor described below. The laser beam that has entered a reflection surface of the polygon mirror 304 is deflected on the reflection surface to become scanning light for scanning the photosensitive drum in a direction (main scanning direction) roughly parallel to a rotational axis of the photosensitive drum.

The laser scanner unit 107a according to the present exemplary embodiment includes a beam detector (BD) 305. The BD 305 is provided to align image forming positions in the main scanning direction. The BD is a sensor set in a position to which scanning light enters, and generates a BD signal in response to the incident scanning light.

Emitting a laser beam based on the image data with a predetermined period of time being elapsed after the generation of the BD signal enables alignment of image forming positions in the main scanning direction during a plurality of scanning operations. An anamorphic lens 306 is located between the polygon mirror 304 and the BD 305, which causes reflected light from the polygon mirror 304 to form an image on the BD 305.

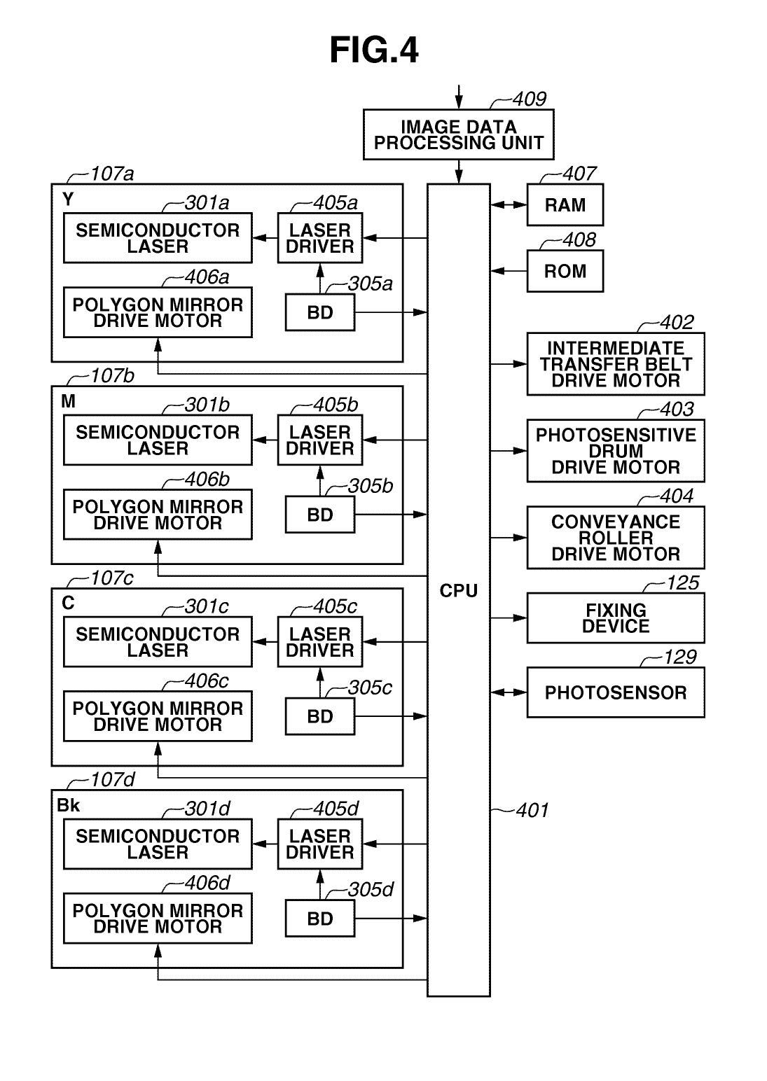

FIG. 4 is a control block diagram illustrating the image forming apparatus according to the present exemplary embodiment. The image forming apparatus according to the present exemplary embodiment includes a CPU 401, and each component is controlled by the CPU 401 as described below.

The CPU 401 controls the laser scanner units 107a to 107d, an intermediate transfer belt drive motor 402 that drives the driving roller 110 to rotate, the driving roller 110 being configured to drive the intermediate transfer belt 104 to rotate, a photosensitive drum drive motor 403 that drives the four photosensitive drums 105a to 105d, a conveyance roller drive motor 404 that drives a conveyance roller (including discharge roller) located on a conveyance path for conveying a recording medium, the fixing device 125, and the photosensor 129.

The laser scanner unit 107a includes a laser driver 405a that drives a semiconductor laser 301a, a polygon mirror drive motor 406a that drives a polygon mirror 304a to rotate, and a BD 305a.

Similarly, the laser scanner unit 107b includes a laser driver 405b that drives a semiconductor laser 301b provided in the laser scanner unit 107b, a polygon mirror drive motor 406b that drives a polygon mirror installed in the laser scanner unit 107b to rotate, and a BD 305b.

The laser scanner unit 107c includes a laser driver 405c that drives a semiconductor laser 301c installed in the laser scanner unit 107c, a polygon mirror drive motor 406c that drives a polygon mirror provided in the laser scanner unit 107c to rotate, and a BD 305c.

The laser scanner unit 107d includes a laser driver 405d that drives a semiconductor laser 301d provided in the laser scanner unit 107d, a polygon mirror drive motor 406d that drives a polygon mirror provided in the laser scanner unit 107d to rotate, and a BD 305d.

The CPU 401 detects densities of density patterns of the respective colors and a relative positional relationship among registration patterns of the respective colors described below.

A random access memory (RAM) 407 is a volatile memory for storing data to be updated. A read-only memory (ROM) 408 is a nonvolatile memory for storing a control flow executed by the CPU 401 during image formation.

An image data processing unit 409 performs color separation for the image data. The processed image data is input to the CPU 401. The CPU 401 transmits a drive signal (PWM signal) to the laser driver included in each laser scanner. The laser driver included in each laser scanner unit drives each semiconductor laser based on the drive signal.

Color misregistration is described. In the electrophotographic image forming apparatus, heat generated by various drive motors or heat generated by the fixing device causes slight deformation of each member. An optical path of a laser beam changes due to such heat deformation, and hence an exposure position on each photosensitive drum shifts from a desired position. As a result, a relative positional relationship among the toner images of the respective colors transferred to the recording medium changes. In other words, a phenomenon of color misregistration where the toner images to be superimposed are not superimposed occurs.

In order to solve the problem, the electrophotographic image forming apparatus performs color misregistration correction control. The color misregistration correction control is executed at predetermined timing, for example, when the processing returns from a standby state immediately after power is turned on, when the number of accumulated formed images after execution of last color misregistration correction control reaches a predetermined number, or when a predetermined period of time elapses after the execution of the last color misregistration control.

The color misregistration correction control can be executed when a change in environmental conditions (temperature and humidity) in which the image forming apparatus is located, vibration of predetermined strength or higher, or a change in characteristics of the image forming apparatus is detected.

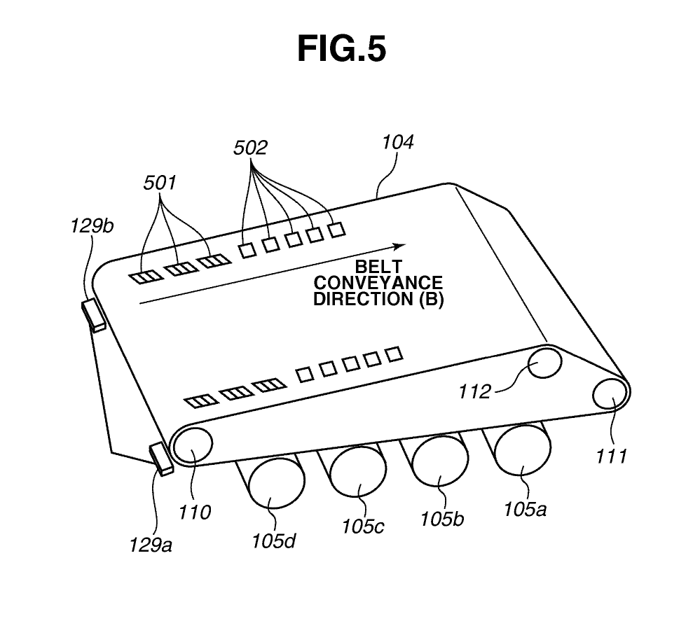

FIG. 5 is an upside-down diagram of the image forming apparatus illustrated in FIG. 1 where the intermediate transfer belt 104, the photosensitive drums 105a to 105d, the driving roller 110, the driven rollers 111 and 112, and the photosensor 129 (129a and 120b) are removed.

During the execution of the color misregistration correction control, in the image forming apparatus according to the present exemplary embodiment, as illustrated in FIG. 5, a registration pattern (position detection pattern) 501 of each color and a density pattern (density detection gradation pattern) 502 are formed on the intermediate transfer belt 104.

The density pattern 502 is a gradation pattern formed to control pattern forming conditions of the registration pattern 501. The registration pattern 501 of each color is desirably formed with the reference density. However, due to changes in characteristics of the image forming apparatus and in the ambient environment (temperature change and humidity change), a density of the registration pattern 501 changes. Hence, a registration pattern of each color is not formed with the reference density, causing a density difference among the registration patterns of the respective colors.

Rising and falling speeds of pulses corresponding to the registration patterns of the respective colors are not equal because of nonuniform densities of the registration patterns of the colors. Hence, detection accuracy of a relative position of the registration pattern 501 is reduced. This reduced detection accuracy causes a drop in color misregistration correction accuracy.

Thus, in the image forming apparatus according to the present exemplary embodiment, the density pattern 502 is formed on the intermediate transfer belt 104. Based on a detection result of the density pattern 502, pattern forming conditions of the registration patterns 501 are controlled so that densities of the registration patterns of the respective colors can be uniform.

The density pattern 502 is described. The density pattern 502 is formed before the registration pattern 501 (on belt conveying direction downstream side of the registration pattern 501) on the intermediate transfer belt 104.

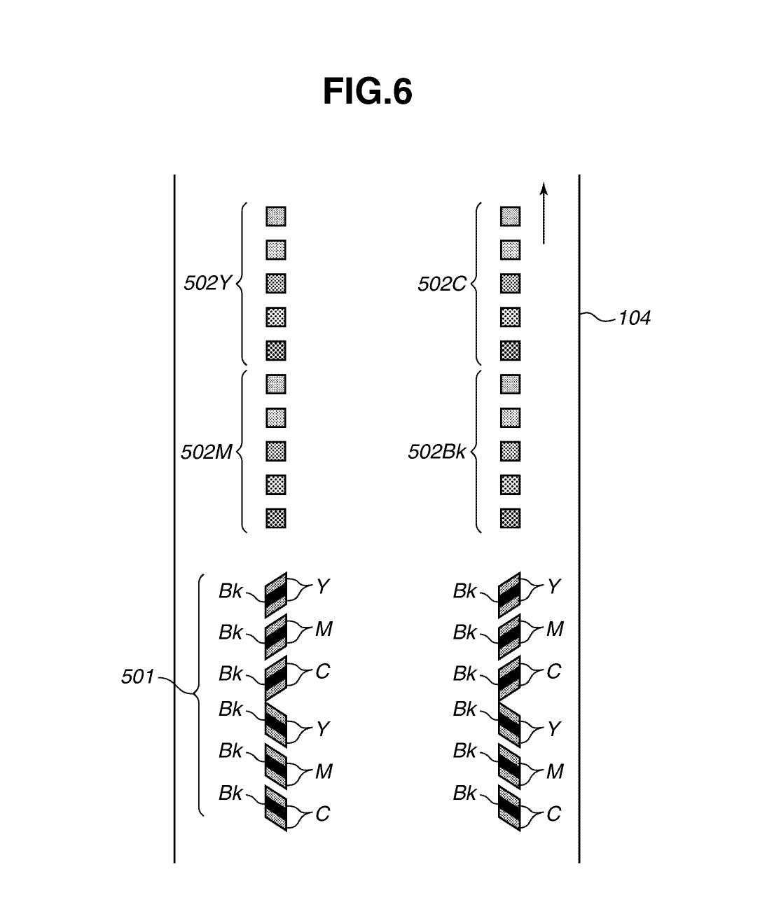

As density patterns 502, as illustrated in FIG. 6, five patches (502Y, 502M, 502C, and 502Bk) different from one another in density are formed on the intermediate transfer belt 104 by using yellow toner, magenta toner, cyan toner, and black toner. The five patches are formed based on pattern forming conditions of the density pattern 502 stored beforehand in the ROM 408 so that they can be formed with densities near the reference density.

For example, the five patches (gradation patterns) are formed, concerning a certain color, with an amount of a laser beam fixed when the density pattern 502 is formed, and pulse widths of PWM signals supplied to the semiconductor laser set to 80%, 85%, 90%, 95%, and 100%.

The amount of the laser beam in this case is equal to that during normal image formation. The normal image means an image formed based on the image data input from the external information apparatus or the reading device.

It is assumed that a pulse width necessary for forming a toner image to fully cover a predetermined area (e.g., area corresponding to one pixel) on the photosensitive drum is 100%. As a pulse width of a PWM signal is larger, an exposing area of the intermediate transfer belt 104 is smaller. Hence, the density of a patch to be detected is higher.

The CPU 401 detects an amount of reflected light from each patch, and determines which of the pulse widths the PWM signal is controlled to in order to form the registration pattern 501 with a density near the reference density.

When a patch formed at the pulse width of 90% is nearest to the reference density, the CPU 401 causes the image forming unit to form the registration pattern 501 by a light amount equal to that when the density pattern 502 is formed and by controlling a pulse width of the PWM signal to 90% (control of pattern forming conditions).

Five patches of densities can be formed by controlling a light amount with a pulse width of the PWM signal fixed. In this case, the five patches are formed by setting a light amount for forming a normal image as a maximum light amount (100%) and reducing light amounts (95%, 90% m, 85%, and 80%) from the maximum light amount.

When a patch formed at the light amount of 90% is nearest to the reference density, the CPU 401 causes the image forming unit to form the registration pattern 501 by a pulse width equal to that when the density pattern 502 is formed and by controlling a light amount to 90%.

Next, the registration pattern 501 is described. In the image forming apparatus according to the present exemplary embodiment, as the registration pattern 501, a superimposed pattern where a black toner image is superimposed on a color toner image is formed. The black toner absorbs light, and hence an amount of reflected light is smaller than others. Glossiness of the surface of the intermediate transfer belt 104 is high. Thus, as reflected light amounts from the belt surface, an amount of specular reflected light is large while an amount of diffused reflected light is small.

When a forming position of the black toner image is identified by using a diffused reflected light detection sensor, a difference between a diffused reflected light amount from the black toner image and a diffused reflected light amount from the intermediate transfer belt is small, and thus detection of the forming position of the black toner image is difficult.

In consequence, when the black toner image is formed as a registration pattern independently of a toner image of each color, the CPU 401 cannot identify a relative positional relationship between the yellow, magenta, and cyan toner images and the black toner pattern.

In the image forming apparatus according to the present exemplary embodiment, therefore, as the registration pattern 501, a superimposed pattern where an achromatic black toner image is superimposed on a chromatic color toner image (base pattern) such as yellow, magenta, or cyan is formed. As illustrated in FIG. 6, in the image forming apparatus according to the present exemplary embodiment, a superimposed pattern where the black toner image is superimposed on each of parallelogram base patterns that are yellow, magenta, and cyan toner images is formed.

The black toner image is formed on the base pattern in such a manner that a part of the base pattern can be exposed on the conveying-direction upstream side (rear end side) and the downstream sided (front end side) of the intermediate transfer belt 104.

The CPU 401 detects, by utilizing a difference between output levels of detection signals from the photosensor 129 generated by a difference in reflected light amount between the color toner image and the black toner image, a relative deviation amount between the color toner image as the base pattern and the black toner image formed on the base pattern.

In the image forming apparatus according to the present exemplary embodiment, the black toner image is used as a reference color. The CPU 401 calculates a deviation amount between the black toner image and the yellow toner image based on the superimposed pattern where the black toner image is superimposed on the yellow toner image.

Similarly, the CPU 401 calculates a deviation amount between the black toner image and the magenta toner image based on the superimposed pattern where the black toner image is superimposed on the magenta toner image. The CPU 401 calculates a deviation amount between the black toner image and the cyan toner image based on the superimposed pattern where the black toner image is superimposed on the cyan toner image.

The CPU 401 controls the image forming units 103Y, 103M, and 103C to reduce the deviation amounts between the toner images of the respective colors and the black toner image.

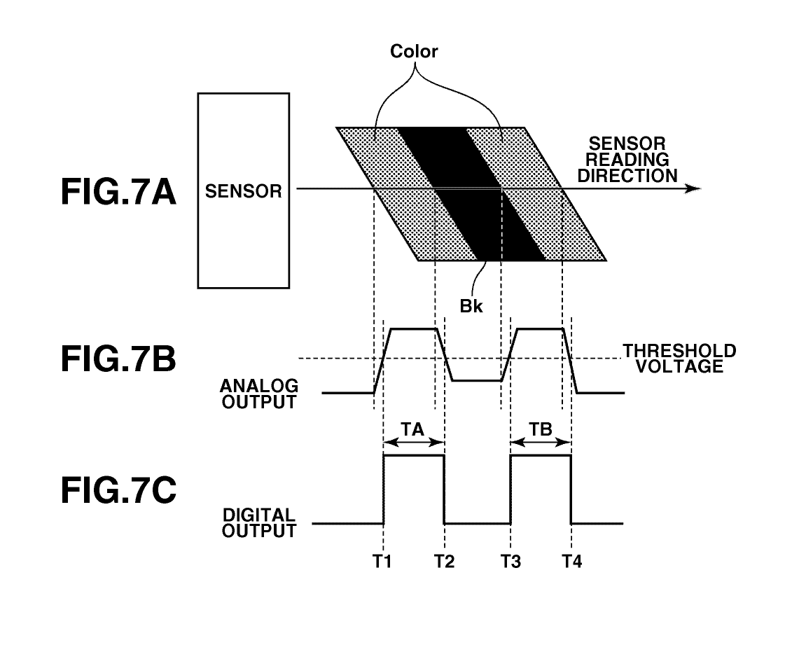

FIGS. 7A to 7C schematically illustrate a superimposed pattern, and waveforms of detection signals output from the CCD 202 in response to reflected light received from the superimposed pattern and reflected light received from the intermediate transfer belt 104 around the superimposed pattern.

FIG. 7A illustrates the superimposed pattern. FIG. 7B illustrates an analog signal output from the photosensor 129 when the superimposed pattern passes through a detection position of the photosensor 129. FIG. 7C illustrates a digital signal acquired by binarizing the analog signal using a comparator.

The comparator outputs a digital signal of a high (H) level when an analog signal equal to or more than a threshold voltage is input, and a digital signal of a low (L) level when an analog signal less than the threshold voltage is input.

As illustrated in FIG. 7B, a diffused reflected light amount from color toner is larger than those from the intermediate transfer belt 104 and the black toner. The CCD 202 that receives diffused reflected light from the superimposed pattern outputs a detection signal of a waveform illustrated in FIG. 7B.

In other words, when the diffused reflected light amount from the color toner is large, an output level of the analog signal becomes high. When the diffused reflected light amounts from the black toner and the intermediate transfer belt 104 are large, an output level of the analog signal becomes low.

As illustrated in FIG. 7B, the threshold voltage is set between a peak value of the analog signal and output levels respectively acquired by detecting the diffused reflected light from the intermediate transfer belt 104 and the diffused reflected light from the black toner.

In FIG. 7C, the CPU 401 detects four edges of rising timings T1 and T3 and falling timings T2 and T4 of a pulse of the digital signal output from the comparator.

The timing T1 corresponds to a leading edge position of the base pattern. The timing T2 corresponds to a leading edge position (boundary between the base pattern and the black toner image) of the black toner image formed on the base pattern. The timing T3 corresponds to a trailing edge position (boundary between the base pattern and the black toner image) of the black toner image. The timing T4 corresponds to a rear edge position of the base pattern.

The CPU 401 calculates time TA that is a difference between T1 and T2, and time TB that is a difference between T3 and T4. TA=TB when there is no deviation in relative forming position between the color toner image of the base pattern and the black toner image formed on the base pattern.

In the case of TA<TB or TA>TB, the CPU 401 determines that there is deviation in relative forming positions between the color toner image of the base pattern and the black toner image formed on the base pattern, and controls timing of forming a toner image corresponding to a color of the base pattern based on the deviation amount (difference between TA and TB).

Next, deterioration in color misregistration detection accuracy caused by nonuniformity of densities of the color toner images included in the superimposed pattern is described. When a color toner image is formed with a density different from the reference density, a rising speed and a falling speed of a pulse are changed.

Thus, timings of rising and falling of the output waveform to cross the threshold voltage are different between when the color toner image is formed with the reference density and when the color toner image is formed with a density different from the reference density.

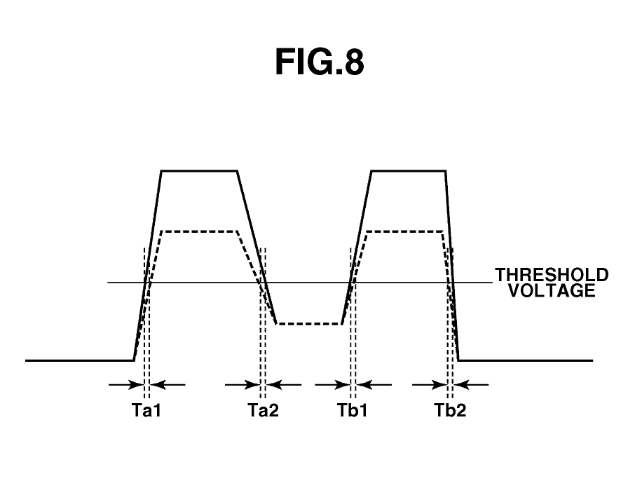

FIG. 8 illustrates an output waveform (solid line) of a detection signal output from the photosensor 129 when the color toner image and the black toner image are formed with the reference density, and an output waveform (dotted line) of a detection signal output from the photosensor 129 when the color toner image is formed with a density lower than the reference density while the black toner image is formed with the reference density.

As illustrated in FIG. 8, when the density of the color toner image decreases, a rising speed and a falling speed of a pulse also decrease. Detection timing differences Ta1, Ta2, Tb1, and Tb2 are accordingly generated between when the registration pattern is formed with the reference density and when not with the reference density.

When change amounts of Ta1, Ta2, Tb1, and Tb2 are equal, even if the color toner image is not formed with the reference density, a relationship between TA and TB is not broken, and hence detection accuracy does not drop. However, as can be understood from FIG. 8, in reality, the change amounts of Ta1, Ta2, Tb1, and Tb2 are not equal. Consequently, when color misregistration correction control is executed by using the output waveform (dotted line), highly accurate detection cannot be executed.

Thus, the CPU 401 controls, based on the detection result of the density pattern 502, the pattern forming conditions of the registration pattern 501 as described above. The registration pattern 501 is formed, based on the adjusted pattern forming conditions, with the reference density by the image forming units 103Y, 103M, 103C, and 103Bk.

Problems concerning density adjustment of the registration pattern in the conventional image forming apparatus are described. The toner is agitated by the agitation device in the developing device to be charged. When a toner charge amount increases, the density of the toner image decreases. Hence, the increased toner charge amount may disable formation of a registration pattern with the reference density.

The toner charge amount is influenced by humidity of an environment in which the toner is located. When there is water vapor around the toner, charges move from the toner into the water vapor. When an amount of water vapor is large, an amount of charges emitted from the toner is also large.

A toner charge amount at humidity of 70% accordingly becomes smaller than that at humidity of 30%. When a potential difference between a developing potential (developing bias) in the developing device and a potential of a part exposed by the exposure device is equal, a density of an image at the humidity of 70% is higher than that of a registration pattern at the humidity of 30%.

When the toner charge amount increases, the toner charge amount can be reduced by replenishing the apparatus with new toner. However, the toner charge amount does not decrease immediately after the new toner is supplied. Hence, the density of the image does not immediately increase.

To suppress reduction in position detection accuracy, therefore, the registration pattern formation must be waited until the developer is agitated and the toner charge amount decreases to a charge amount that enables formation of a registration pattern with the reference density. In this case, execution timing of color misregistration correction control is delayed, and hence a period where no image is formed is prolonged.

To compensate for the density reduction of the registration pattern 501 caused by the increased toner charge amount, the density of the registration pattern 501 can be increased to the reference density by increasing the amount of a laser beam (exposure intensity) for forming the registration pattern 501.

However, the registration pattern 501 is formed at a position on the intermediate transfer belt 104 where it can be detected by the photosensor 129. Consequently, when the exposure intensity for forming the registration pattern 501 is increased, deterioration of the portion where the registration pattern 501 is formed on the photosensitive drum progresses.

In order to suppress reduction in color misregistration correction accuracy even when the registration pattern 501 cannot be formed with the reference density, the image forming apparatus according to the present exemplary embodiment executes control described below.

In the control described below, color misregistration detection accuracy decreases more than that when the registration pattern of each color is formed with the initial reference density. However, color misregistration can be detected more accurately than when color misregistration is corrected in a nonuniform density state of the registration patterns of the respective colors. The color misregistration can be corrected without waiting for reduction in toner charge amount, and the processing can proceed to image formation. As a result, down time can be reduced.

Concerning at least one density pattern among density patterns of a plurality of colors, when it is determined that one of a highest density among five patches of the density patterns 502 has been formed with a density lower than the reference density, the CPU 401 determines that the color toner image included in the superimposed pattern cannot be formed with the reference density.

When it is determined that the color toner image cannot be formed with the reference density, the CPU 401 controls at least one of a pulse width of a PWM signal and exposure intensity so as to match a density of the color toner image included in the superimposed pattern with that of a color where the density pattern has been formed with a lowest density.

For example, it is presumed that a maximum density of the patch of the yellow density pattern is detected to be 1.25, a maximum density of the patch of the magenta density pattern is detected t be 1.40, and a maximum density of the patch of the cyan density pattern is detected to be 1.40.

A value of a voltage corresponding to the reference density is higher than that of the threshold voltage illustrated in FIG. 7B. In this case, because of formation of the yellow density pattern with the density lower than the reference density, the CPU 401 determines that the color toner image included in the yellow superimposed pattern cannot be formed with the reference density, and determines that the color toner images included in the superimposed patterns of the other colors can be formed with the reference density.

Since the maximum density of the patch of the yellow density pattern is 1.25, the CPU 401 changes the reference density of the color toner image of each color included in the superimposed pattern to 1.25. The CPU 401 then executes at least one of control to narrow the pulse width of the PWM signal and control to reduce the amount of a laser beam so that the magenta toner image and the cyan toner image included in the superimposed pattern can be formed with the density of 1.25.

The yellow toner image included in the superimposed pattern is formed on the same pattern forming conditions as those of the patch formed with the density of 1.25 and included in the yellow density pattern.

Thus, in the image forming apparatus according to the present exemplary embodiment, even in a state where at least one of the plurality of color toner images cannot be formed with the reference density, the color toner images of the respective colors included in the superimposed pattern are formed to match one another in density lower than the initial reference density.

This arrangement can suppress deterioration in detection accuracy of the registration pattern 501 even when the registration pattern cannot be formed with the reference density. Color misregistration correction can be executed before the apparatus reaches a state where the registration pattern 501 can be formed with the reference density.

An increase of the amount of a laser beam with respect to a certain amount of light that causes deterioration of the photosensitive drum to exceed an acceptable range can be calculated when it is designed. When the increase of the laser beam amount can be limited within the acceptable range, by increasing the laser beam amount for color toner having its density pattern formed with a density lower than the reference density before the change, a density of the color toner image included in the superimposed pattern can be increased.

For example, when a maximum density of the patch of the yellow density pattern is detected to be 1.25, the reference density can be changed to 1.30 higher than 1.25. In this case, it is known beforehand that even when the amount of a laser beam is increased to form the yellow toner image with a density of 1.30, deterioration of the photosensitive drum is within the acceptable range.

The CPU 401 accordingly transmits, to the laser driver 405a, an instruction for increasing an amount of a laser beam emitted from the semiconductor laser 301a so that the yellow toner image of the superimposed pattern can be formed with the density of 1.30.

The CPU 401 adjusts a density of the black toner image formed on the color toner image included in the superimposed pattern. The black toner image is formed with a black reference density set separately from that of the color toner image. However, as in the case of the color toner image, the black toner image may not be formed with the reference density.

Thus, when the black toner image cannot be formed with the reference density, the black toner image included in the superimposed pattern is formed on the same pattern forming conditions as those of one having a highest density among the five patches of the black density pattern.

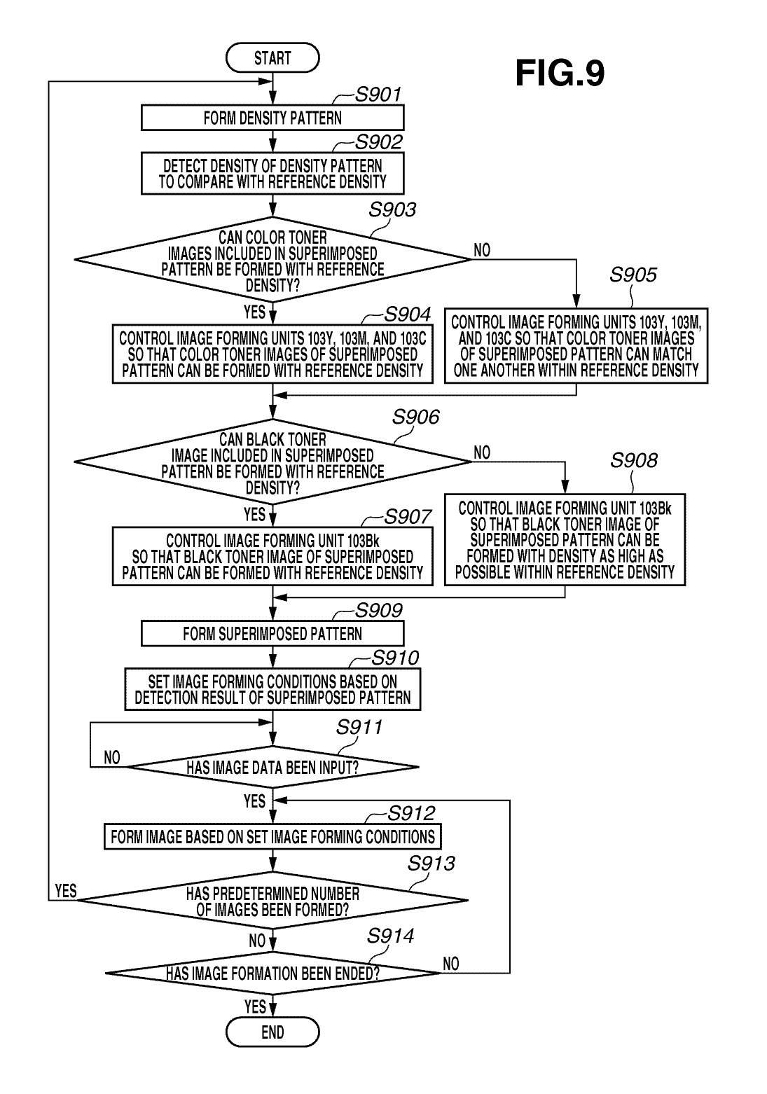

Next, referring to FIG. 9, a control flow executed by the CPU 401 is described. When power is turned on for the image forming apparatus or when the apparatus recovers from a standby state, the CPU 401 starts the control.

First, in step S901, the CPU 401 controls each image forming unit so that the density pattern 502 can be formed on the intermediate transfer belt 104. In step S902, the CPU 401 detects a density (reflected light amount) of each patch of the density pattern based on a detection signal from the photosensor 129, and compares the density with the reference density (or reflected light amount data corresponding to the reference density.

In step S903, the CPU 401 determines whether a color toner image can be formed with the reference density based on the result of the comparison in step S902. When it is determined that the color toner image included in a superimposed pattern can be formed with the reference density (YES in step S903), in step S904, the CPU 401 controls the image forming units 103Y, 103M, and 103C so that the color toner images included in the superimposed pattern can be formed with the reference density.

When it is determined that the color toner image included in the superimposed pattern cannot be formed with the reference density (NO in step S903), in step S905, the CPU 401 controls the image forming units 103Y, 103M, and 103C so that color toner images of respective colors included in the superimposed pattern can be formed with a matched density lower than the reference density.

When it is determined in step S904 that the color toner images included in the superimposed pattern can be formed with the reference density, it means that the reference density is included between a maximum density and a minimum density of the patches of the density patterns 502Y, 502M, and 502C. In this case, on the same pattern forming conditions as those of one of the five patches, the color toner images can be formed with a density near the reference density.

After step S904 or step S905, in step S906, the CPU 401 determines whether a black toner image included in the superimposed pattern can be formed with the reference density. When it is determined that the black toner image included in the superimposed pattern can be formed with the reference density (YES in step S906), in step S907, the CPU 401 controls the image forming apparatus 103Bk so that the black toner image included in the superimposed pattern can be formed with the reference density.

When it is determined that the black toner image included in the superimposed pattern cannot be formed with the reference density (NO in step S906), in step S908, the CPU 401 controls the image forming apparatus 103Bk so that the black toner image included in the superimposed pattern can be formed with a density as near as possible to the reference density.

When it is determined in step S906 that the black toner image included in the superimposed pattern can be formed with the reference density, it means that the reference density is included between a maximum density and a minimum density of the patch of the density pattern 502Bk. In this case, on the same pattern forming conditions as those of one of the five patches, the black toner image can be formed with a density near the reference density.

In step S909, based on the processing in steps S903 to S907, the CPU 401 controls each image forming unit so that the superimposed pattern can be formed on the intermediate transfer belt 104 (image bearing member). In step S910, the CPU 401 sets image forming conditions to reduce color misregistration based on the detection result of the superimposed pattern.

After step S910, in step S911, the CPU 401 determines whether image data has been input. When it is determined that the image data has been input (YES in step S911), in step S912, the CPU 401 causes each forming unit to form an image based on the image forming conditions set in step S910.

After step S912, in step S913, the CPU 401 determines whether images have been formed on a predetermined number of recording media. When it is determined that the images have been formed on the predetermined number of recording media (YES in step S913), the processing returns to step S901.

When it is determined that images have not been formed on the predetermined number of recording media (NO in step S913), in step S914, the CPU 401 determines whether formation of all the images based on the image data has been ended.

When it is determined that the image formation has been ended (YES in step S914), the CPU 401 ends the control. When it is determined that the image formation has not been ended (NO in step S914), the processing returns to step S912.

As described above, even in the apparatus state where the registration patterns cannot be formed with the density equal to or higher than the reference density, down time can be reduced by forming the registration patterns at a matched density equal to or lower than the reference density.

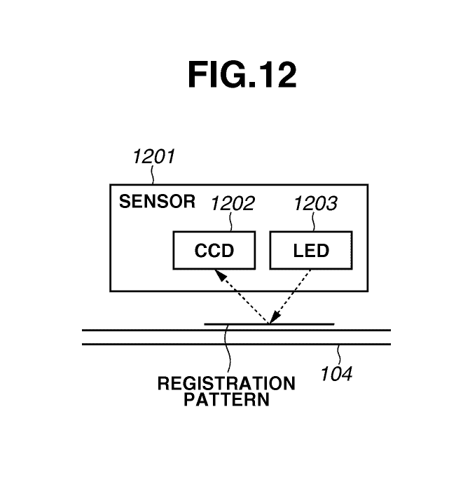

In place of the abovementioned photosensor 129, a photosensor 1201 of a specular reflected light receiving type illustrated in FIG. 12 can be used. The photosensor 1201 includes a LED 1203 that emits light. A CCD1 1202 is located to receive a registration pattern of the light or reflected light from the intermediate transfer belt 104.

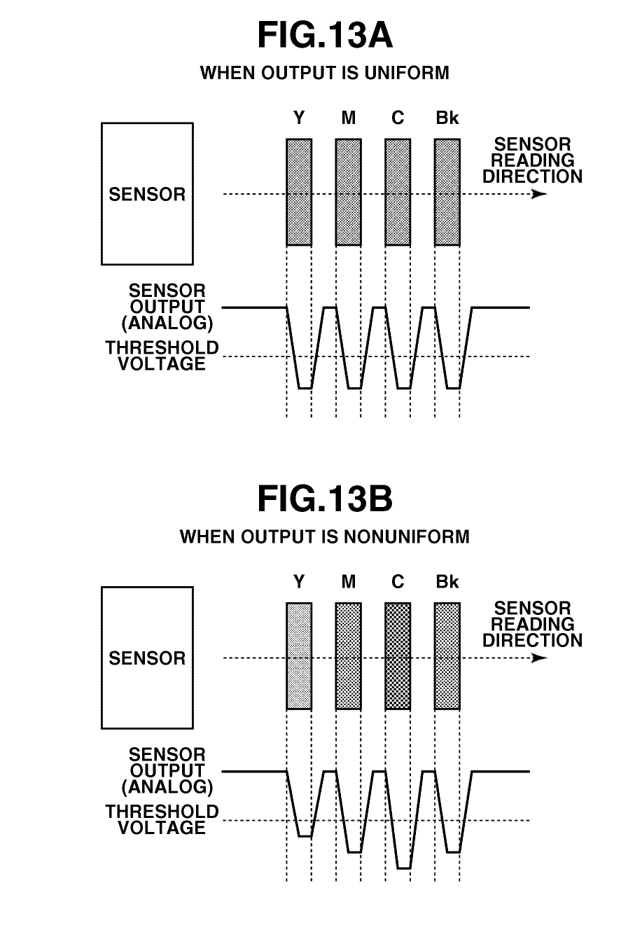

An output from the CCD 1202 of the photosensor 1201 is, as illustrated in FIGS. 13A and 13B, different from that from the CCD of the photosensor 129. FIG. 13A illustrates a case where an output of an analog signal from the CCD 1202 is uniform. FIG. 13B illustrates a case where the output of the analog signal from the CCD 1202 is nonuniform.

A light reflectance is higher on the intermediate transfer belt 104 than on the registration pattern. Since the photosensor 1201 is the specular reflected light reception sensor, an output of the CCD 1202 when specular reflected light is received from the intermediate transfer belt 104 is larger than that of the CCD 1202 when reflected light is received from the registration pattern.

The CPU 401 converts the output from the CCD 1202 into a digital value based on the output from the CCD 1202 and the threshold voltage to detect relative positions of the registration patterns of respective colors.

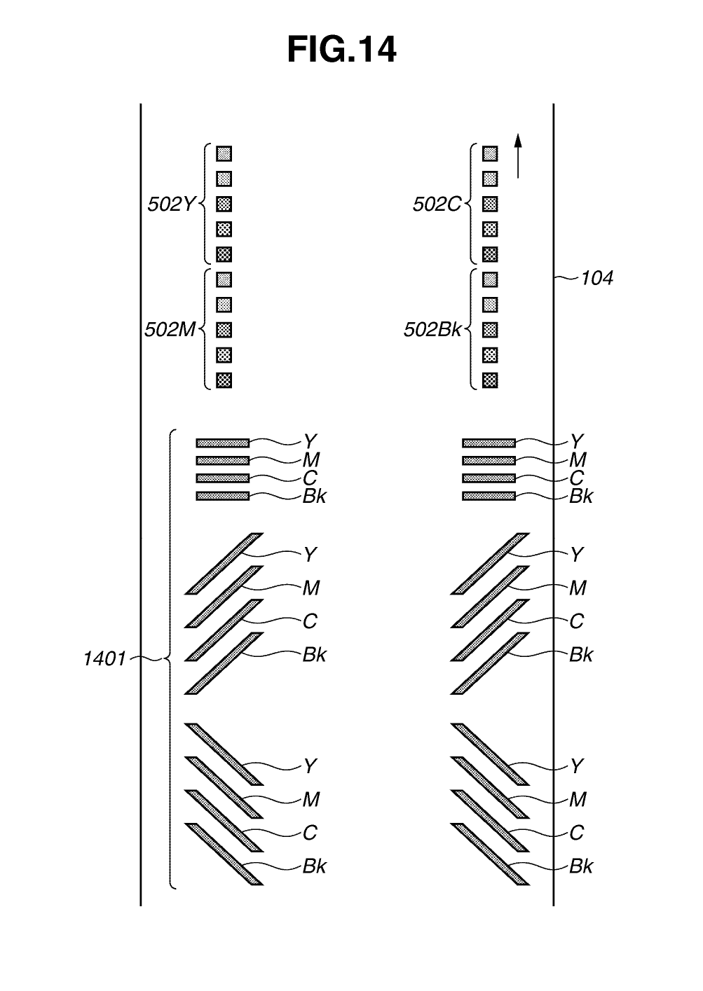

FIG. 14 schematically illustrates a registration pattern 1401 when the photosensor 1201 is used. The density pattern (density detection gradation pattern) 502 illustrated in FIG. 6 is formed before the registration pattern 1401 is formed. A density of the registration pattern 1401 is controlled based on a detection result of the density pattern 502.

As described above, FIG. 3B illustrates the case where the output of the analog signal from the CCD 1202 is nonuniform. In this case, it is presumed that the yellow registration pattern alone cannot be formed with a density to acquire a target output level.

In this case, the CPU 401 controls the image forming units 405b, 405c, and 405d to reduce densities of other registration patterns. The CPU 401 also controls the densities of the registration patterns to prevent an output from the CCD 1202 corresponding to each registration pattern from exceeding the threshold voltage. It is because when the densities of the registration patterns exceed the threshold voltage, relative positions of the registration patterns cannot be detected.

The CPU 401 can select densities of the registration patterns of the respective colors so that output levels from the CCD 1202 corresponding to the registration patterns can be uniform.

In an apparatus that detects color misregistration by using a superimposed pattern, an offset amount is generated between an actual deviation amount where a color toner image included in the superimposed pattern is formed with a density lower than a reference density and a detected deviation amount.

Specifically, when a color toner image is formed with a lowered density, as compared with a case where a color toner image is formed with the reference density, timings Ta1, Ta2, Tb1, and Tb2 of a rising edge and a falling edge of a pulse of a detection signal output from a photosensor 129 by detecting the superimposed pattern change as illustrated in FIG. 8.

In the case of Ta1=Ta2=Tb1=Tb2, there is no influence on accuracy of detecting a deviation amount between a black toner image and the color toner image included in the superimposed pattern. However, Ta1=Ta2=Tb1=Tb2 is not set due to an influence of setting accuracy of the photosensor 129, thereby generating the offset amount.

The offset amount is generated in a sub-scanning direction (rotational direction of a photosensitive drum or conveying direction of an intermediate transfer belt). The offset amount can be calculated according to a density control amount in designing as illustrated in Table 1 below. A CPU 401 executes, when one of the color toner image and the black toner image included in the superimposed pattern is changed in density to be formed, control to correct the offset amount.

TABLE 1

| Color toner image | Black toner image | |
|---|---|---|
| density | density | Offset amount |
| 1.40 | 1.40 | 0 |
| 1.30 | 1.40 | 20 |
| 1.20 | 1.40 | 40 |
| 1.10 | 1.40 | 60 |

As described above, reference densities for both toner images are 1.40. When both toner images are formed with the reference densities, no correction is necessary, and hence an offset amount is 0 μm. An offset amount is 40 μm when the black toner image can be formed with the reference density while the color toner image is formed with a density of 1.20 lower than the reference density.

An image forming position in the sub-scanning direction can be corrected by accelerating or delaying output timing of a laser beam. In an image forming apparatus according to the present exemplary embodiment, when an offset amount is 20 micrometers, the image forming position can be corrected by accelerating or delaying the output timing of the laser beam only by one surface of a polygon mirror.

When an offset amount is 40 μm, the image forming position can be corrected by accelerating or delaying the output timing of the laser beam only by two surfaces of the polygon mirror. When an offset amount is 60 μm, the image forming position can be corrected by accelerating or delaying the output timing of the laser beam only by three surfaces of the polygon mirror.

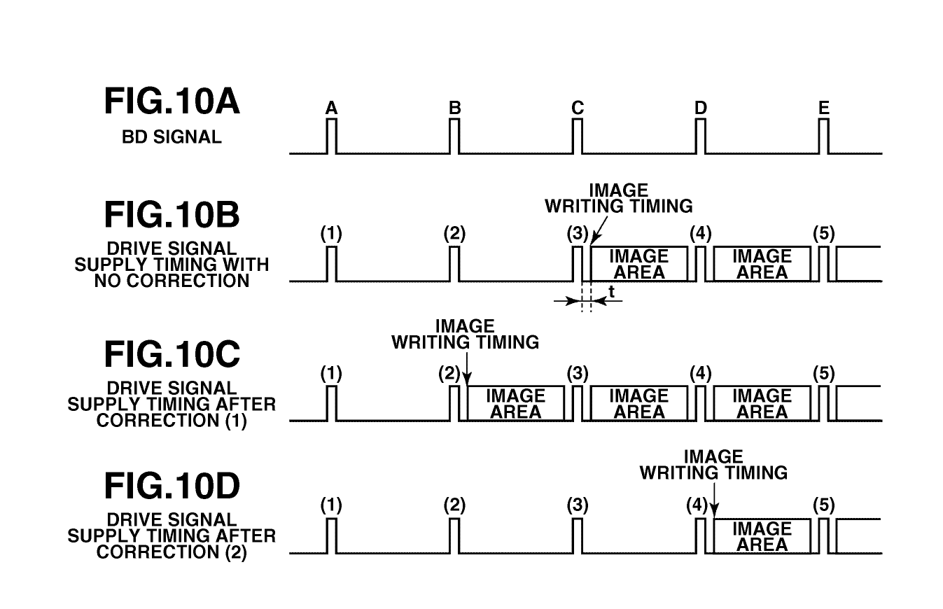

Referring to FIGS. 10A to 10D, a method of correcting the image forming position in the sub-scanning direction is described. FIG. 10A illustrates output timing of a BD signal output from a BD 305. Each of FIGS. 10B to 10D illustrates supply timing of a drive signal from the laser driver of each image forming unit to a semiconductor laser.

FIG. 10B illustrates an example where laser output timing for forming an electrostatic latent image is not adjusted. In other words, when offset amount is 0 μm, formation of an electrostatic image is started in response to detection of a BD signal C.

Each of FIGS. 10C and 10D illustrates an example where the image forming position in the sub-scanning direction is adjusted by adjusting laser output timing during electrostatic latent image formation. FIG. 10C illustrates the example where formation of an electrostatic latent image is started before that illustrated in FIG. 10B.

As illustrated in FIG. 10C, the formation of the electrostatic latent image is started in response to detection of a BD signal B. Starting the formation of the electrostatic latent image in response to the detection of the BD signal generated at timing before the BD signal C enables shifting of the image forming position to a rotational-direction downstream side of the photosensitive drum (conveying-direction downstream side of the intermediate transfer belt 104 or conveying-direction leading edge side of recording paper).

FIG. 10D illustrates an example where formation timing of an electrostatic latent image is delayed from that illustrated in FIG. 10B.

As illustrated in FIG. 10D, the formation of the electrostatic latent image is started in response to detection of a BD signal D. Starting the formation of the electrostatic latent image in response to the detection of the BD signal generated at timing after the BD signal C enables shifting of the image forming position to a rotational-direction upstream side of the photosensitive drum (conveying-direction upstream side of the intermediate transfer belt 104 or conveying-direction trailing edge side of recording paper).

Thus, changing the BD signal indicating image writing timing enables changing of the image forming position in the sub-scanning direction.

To generate the BD signals A to E in FIG. 10A, drive signals are supplied to the laser drivers as illustrated in FIGS. 10B to 10D. After passage of predetermined time (t illustrated in FIG. 10B) from the input of the BD signal, the laser driver supplies a drive current based on the drive signal (PWM signal) input from the CPU 401 to the semiconductor laser.

In FIGS. 10B to 10D, an “image area” indicates a period where supplying of the PWM signal generated as the drive signal based on input image data is permitted. As illustrated in FIGS. 10A to 10D, the drive signal is not always input to the semiconductor laser in the “image area”.

Thus, changing the laser output timing enables changing of the image forming position in the sub-scanning direction. In the image forming apparatus according to the present exemplary embodiment, a reference color for correcting the image forming position is black toner, and hence the image forming position is changed for the color toner image.

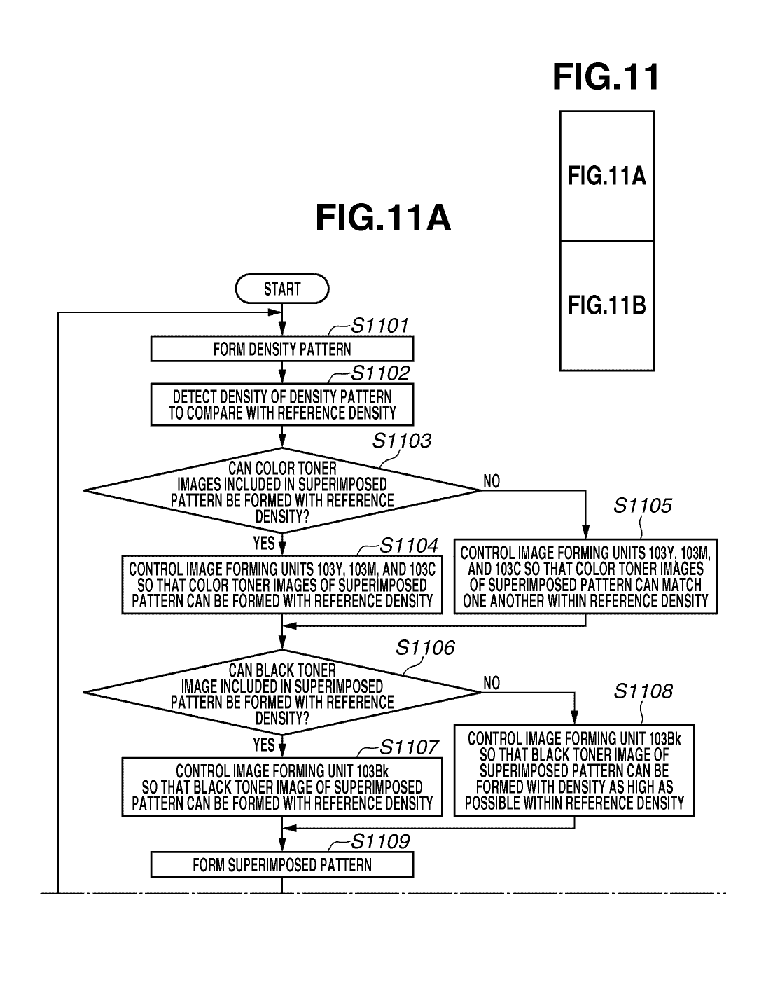

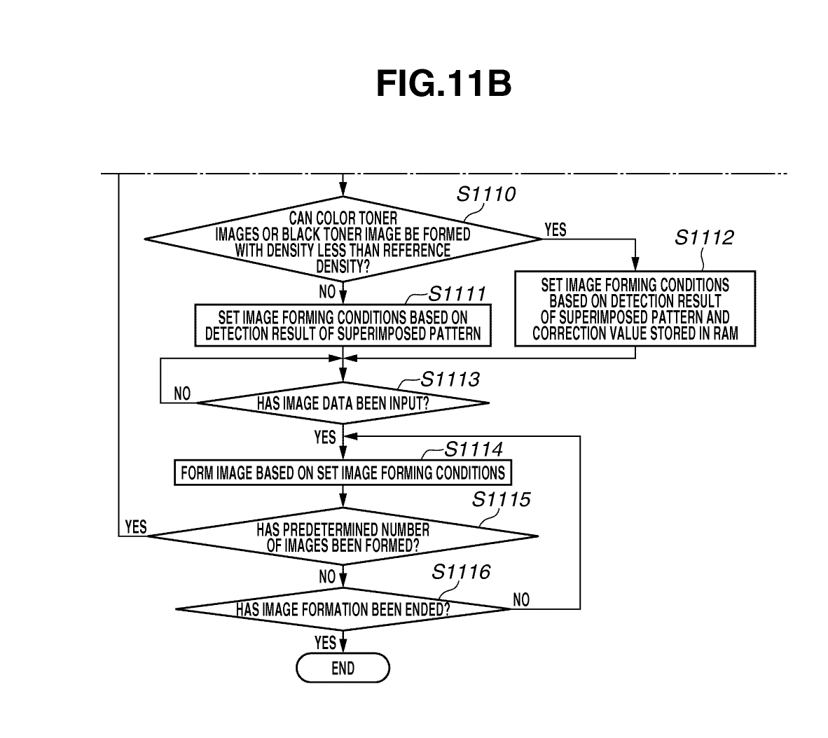

Referring to FIG. 11 (FIGS. 11A+11B), a control flow executed by the CPU is described. The control flow of steps S1101 to S1109 is similar to that illustrated in FIG. 9, and thus description of this portion is omitted.

In step S1110, the CPU 401 determines whether at least one of a color toner image and a black toner image included in a superimposed pattern has been formed with a density lower than a reference density in the previous step.

When it is determined that the color toner image or the black toner image has been formed with the reference density (NO in step S1110), in step S1111, the CPU 401 sets image forming conditions based on a detection result of the superimposed pattern.

When it is determined that at least one of the color toner image and the black toner image included in the superimposed pattern has been formed with a density lower than the reference density (YES in step S1110), in step S1112, the CPU 401 sets image forming conditions based on the detection result of the superimposed pattern and a correction value stored in a RAM 407.

After step S1111 or S1112, in step S1113, the CPU 401 determines whether image data has been input. When it is determined that the image data has been input (YES in step S1113), in step S1114, the CPU 401 causes each forming unit to form an image based on the image forming conditions set in step S1111 or S1112.

After step S1114, in step S1115, the CPU 401 determines whether images have been formed on a predetermined number of recording media. When it is determined that the images have been formed on the predetermined number of recording media (YES in step S1115), the processing returns to step S1101.

When it is determined that images have not been formed on the predetermined number of recording media (NO in step S1115), in step S1116, the CPU 401 determines whether formation of all the images based on the image data has been ended. When it is determined that the image formation has been ended (YES in step S1116), the CPU 401 ends the control. On the other hand, when it is determined that the image formation has not been ended (NO in step S1116), the CPU 401 returns the processing to step S1114.

As described above, correcting color misregistration by adding a correction amount for correcting an offset amount generated due to formation of the registration pattern with the density lower than the reference density to the detection result of the superimposed pattern enables suppression of reduction in color misregistration correction accuracy even when the registration pattern cannot be formed with the reference density.

Aspects of the present invention can also be realized by a computer of a system or apparatus (or devices such as a CPU, a micro processing unit (MPU), and/or the like) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., a computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-183269 filed Aug. 18, 2010, which is hereby incorporated by reference herein in its entirety.

What is claimed is:

1. An image forming apparatus comprising:
an image forming unit configured to form toner images on an image bearing member by using first toner and second toner different from the first toner, and to form, on the image bearing member, a first position detection pattern by using the first toner and a second position detection pattern by using the second toner;
a detection unit configured to detect the first position detection pattern and the second position detection pattern, and to output a first signal according to a density of the first position detection pattern and a second signal according to a density of the second position detection pattern;
a correction unit configured to correct relative positions of the toner image formed by the first toner and the toner image formed by the second toner on the image bearing member based on the first signal and the second signal; and
a control unit configured to control, in a case in which an output level of the first signal reaches a predetermined level corresponding to the first signal while an output level of the second signal does not reach a predetermined level corresponding to the second signal, the density of the second position detection pattern so that the second signal having the level not reaching the predetermined level corresponding to the second signal can be output from the detection unit.

2. The image forming apparatus according to claim 1,
wherein the image forming unit forms a first gradation pattern by using the first toner and a second gradation pattern by using the second toner,
wherein the detection unit detects the first gradation pattern and the second gradation pattern, and outputs signals according to densities thereof, and
wherein the control unit determines, by comparing an output level corresponding to a maximum density of the signals output from the detection unit with a predetermined level based on the first gradation pattern and the signals output from the detection unit with a predetermined level based on the second gradation pattern, whether the first position detection pattern and the second position detection pattern can be formed with densities with the corresponding predetermined levels.

3. The image forming apparatus according to claim 2,
wherein the image forming unit includes a first photosensitive member and a second photosensitive member, a first light source configured to emit a light beam for forming an electrostatic latent image on the first photosensitive member, a second light source configured to emit a light beam for forming an electrostatic latent image on the second photosensitive member, a first developing unit configured to develop the electrostatic latent image formed on the first photosensitive member by using the first toner, a second developing unit configured to develop the electrostatic latent image formed on the second photosensitive member by using the second toner, and a transfer unit configured to transfer the toner images developed on the first photosensitive member and the second photosensitive member to the image bearing member, and
wherein the control unit controls the densities of the first position detection pattern and the second position detection pattern by controlling amounts of the light beams projected to the first photosensitive member and the second photosensitive member from the first light source and the second light source.

4. The image forming apparatus according to claim 3, wherein the control unit controls the densities of the first position detection pattern and the second position detection pattern by controlling intensities of the light beams emitted from the first light source and the second light source.

5. The image forming apparatus according to claim 3, wherein the control unit controls the densities of the first position detection pattern and the second position detection pattern by controlling output periods of time of the light beams for forming the first position detection pattern and the second position detection pattern.

6. The image forming apparatus according to claim 1, wherein in a case in which the control unit controls the densities of the first position detection pattern and the second position detection pattern so that the first signal and the second signal of the levels lower than the predetermined levels can be output from the detection unit, the correction unit corrects the relative positions of the first toner image and the second toner image based on a difference between the predetermined levels and the output level of the first signal and the output level of the second level lower than the predetermined levels, and the first signal and the second signal.

7. The image forming apparatus according to claim 1,
wherein the image forming unit forms toner images on the image bearing member by using black toner and color toner;
wherein the detection unit irradiates a superimposed pattern with light to detect diffused reflected light from the superimposed pattern,
wherein the image forming unit forms, as the first and second position detection patterns, a superimposed pattern in which one of a plurality of color images is superimposed on a black toner image so that a part of the black toner image can be exposed on the image bearing member, and
wherein the correction unit calculates, based on the first signal output from the detection unit by detecting the black toner image included in the superimposed pattern, and the second signal output from the detection unit by detecting the color toner image included in the superimposed pattern, a deviation amount between the relative positions of the black toner image and the color toner image included in the superimposed pattern, and controls the image forming unit to reduce the deviation amount.
